(19) United States
(12) Patent Application Publication
(10) Pub. No.: US 2005/0242468 A1
(43) Pub. Date: Nov. 3, 2005

(54) Composite capping block

(76) Inventors: Robert A. MacDonald, Plymouth, MN (US); William B. Dawson, Medina, MN (US)

Correspondence Address: POPOVICH, WILES & O'CONNELL, PA;650 THIRD AVENUE SOUTH, SUITE 600, MINNEAPOLIS, MN, 55402, US

(21) Appl. No.: 11/117,639

(22) Filed: Apr. 28, 2005

Related U.S. Application Data
(60) Provisional application No. 60/566,617, filed on Apr. 29, 2004.

(51) Int. Cl. B29C 70/58

(52) U.S. Cl. 264/255

(57) ABSTRACT

A capping block having a waterproof shell that enables the quick and easy construction of a structurally sound column or pillar. The capping block comprises a composite material that has the appearance of natural stone.

This application claims the benefit of provisional application Ser. No. 60/566,617, filed Apr. 29, 2004, the contents of which are hereby incorporated herein by reference.

### FIELD OF THE INVENTION

A system of interlocking modular blocks is described, and in particular, capping blocks used in such a system are described.

### BACKGROUND OF THE INVENTION

Columnar structures used for decoration or as support for fence panels, gates or other such structures have required a considerable amount of skill and effort to erect. Conventional systems primarily include mortared masonry blocks. Columns or pillars also have been made from stone, but this requires skilled craftspeople to ensure proper structural completion. Modular blocks have also been used to build columns or pillars. Such blocks can be installed with construction adhesive to strengthen the connection between layers and may also be used with mortar to simulate the appearance of a more conventional block and mortar column.

An important feature of columns and pillars is their appearance. The use of a capping block to finish off the structure is very appealing and the art provides several methods for producing capping blocks. One method requires a skilled craftsperson to cut natural stone, such as granite or limestone using hand tools or specialized equipment. This approach results in considerable waste, and such capping blocks are heavy and thus inherently expensive to ship and difficult to install.

Concrete imitation stone is also used to produce another type of capping block used in the production of a column or pillar. To produce such concrete imitation stone, a flexible mold formed of latex or urethane is sprayed with a pigment and then filled with concrete, which may also be colored. These products evoke the look of natural stone by virtue of the mold being textured to imitate the texture of natural stone, while the use of appropriate pigments mimics the colors found in natural stone. While such products evoke the look of natural stone, a discerning eye can spot that they are not the real thing. In addition these blocks are very heavy, and this makes them expensive to ship.

Both natural stone and concrete imitation stone capping blocks are solid masses and there is no space within the blocks for electrical wiring or conduit. These products are also difficult to drill through to provide a space for wiring or conduit. Both natural stone and concrete caps typically absorb water, thus wiring is susceptible to exposure to moisture and to corrosion. The lack of waterproofing permits masonry beneath the capping block to be exposed to freeze/thaw cycles that can affect the durability of the whole structure. Currently available capping blocks generally do not have a means to lock onto the block located directly below, complicating centering the capping block onto the column or pillar structure, and not providing a structural interlock between the capping block and the base of the column.

An important feature of the capping blocks is their appearance. The look of weathered natural stone is very appealing for columns and other similar structures. The art provides several methods to produce concrete blocks having an appearance that to varying degrees mimics the look of natural stone. According to one well-known method, blocks are individually formed in a mold and the surfaces are textured by removal of the mold. Additional machine texturing processes can then be applied. The look of smooth cut stone can also be very attractive for columns and other structures. The smooth texture provides a more straight edge, formal, geometric shape for the block and overall structural appearance.

Given the disadvantages of conventional capping blocks, there is a need for a capping block which will overcome the disadvantages listed above. Specifically, there is a need for a capping block which is relatively inexpensive to manufacture, reduced in weight, and which contains a means to enable the quick and easy construction of structurally sound, column or pillar. In addition, it would be highly desirable to have a waterproof capping block that would have space for electrical wiring and/or structural components. Such a capping block would provide resistance to corrosion and freeze/thaw effects.

### SUMMARY OF THE INVENTION

The present invention provides a capping block comprising a waterproof shell that enables the quick and easy construction of a structurally sound, column or pillar. The capping block has the appearance of natural stone.

This invention is a fiberglass capping block configured to be compatible to fit atop columnar blocks in the construction of a pillar or column. Each capping block has at least four faces and is textured in a manner resulting in an appearance like that of natural granite or limestone. The capping block preferably is formed of a composite shell composed of a layer of a stone particle-resin mixture and a fiberglass/resin substrate. The faces have varying sizes based on variations in width. The orientation of the faces may be reversed so that the back or the side of the block may be the front. The capping blocks can have a variety of different designs and styles in order to give the block different aesthetic appearances.

The capping blocks are provided with a lip around the perimeter of the block in order to attach the column cap to the structure below. The capping block may be hollow in order to allow room for electrical wiring and/or a compression plate. The capping block may also be filled with insulation. The capping block is a cost-effective natural stone mimic, greatly reduced in weight but with added durability compared to current capping blocks.

### BRIEF DESCRIPTION OF THE DRAWINGS

FIG. 1A is a sectional view of a mold used to form a cap, and FIG. 1B is a sectional view of the cap.

FIG. 2A is a perspective view of a shelf pan, and FIG. 2B is a perspective view of the shelf pan fitted into the cap.

FIGS. 3A and 3B are top and bottom perspective views, respectively, of the columnar capping block of this invention.

FIGS. 4A and 4B are cross-sectional views showing the formation of the capping block with a molded lip.

FIGS. 5A and 5B are perspective and bottom views, respectively, of a capping block having a through-penetration, and FIG. 5C is a side view of the capping block of FIG. 5A having a light fixture attached therethrough.

FIG. 6A is a cut away view of a capping block used in conjunction with a compression plate and FIG. 6B is a top view of the compression plate.

FIGS. 7A to 7H are perspective views of various embodiments of the capping block.

### DETAILED DESCRIPTION OF THE PREFERRED EMBODIMENTS

In this invention a capping block is used as the top layer of a column or pillar. The column may comprise stone, wood, or like materials, and in preferred embodiments the column comprises modular blocks that are stacked together. The column is formed on a base layer. The blocks may each have a core or may be stacked together such that they form a core. Vertical reinforcement may be embedded in or attached to the base layer and extend through the cores of adjacent blocks and into the capping block. Such blocks are made of a rugged, weather resistant material, preferably (and typically) zero-slump molded concrete. Other suitable materials include plastic, reinforced fibers, wood, metal and stone. As known in the art, the blocks may be connected to each other by a pin attachment system, or the blocks may be provided with interlocking elements, such as those described in commonly assigned, co-pending U.S. application Ser. No. ______ (Attorney Docket No. KEY1033US) entitled “Column Block System,” filed on even date herewith and hereby incorporated herein by reference, which claims the benefit of commonly assigned, co-pending U.S. Provisional application Ser. No. 60/566,628 entitled “Column Block System,” filed on Apr. 29, 2004 and hereby also incorporated herein by reference.

In this application “upper” and “lower” refer to the placement of blocks as a column is constructed. The lower or bottom surface of blocks is the surface that faces the ground in a column. The first course of the column is formed by placing one block so that its lower surface is face-down. Subsequent courses are formed by stacking blocks one onto the other. “Top” and “bottom” surfaces are defined as those most conventionally used for such blocks. Regardless of the type of column, it should be easy to install and structurally sound.

The capping blocks of this invention preferably comprise a mineral aggregate in fiberglass. This material is produced by mixing stone particles, sand, or mineral with resin. To form the cap portion of the capping block, this material is poured into a mold having a desired cap shape and spread to form a first layer in the mold. Then, in a preferred embodiment, additional resin, mixed with glass fibers, is poured and spread on the first layer to form a second layer. The material then may be cured (i.e., allowed to set and harden and/or heated to accelerate the curing) before further forming steps are carried out. The mold forms a cap which is then joined to a shelf pan comprising the same resin and mineral aggregate mixture. The cap and shelf pan may be joined together by virtue of uncured resin or additional adhesive may be used.

If cured before contact with the shelf pan, adhesive is used to join the shelf pan to the cap. When uncured, the resin layers bond together.

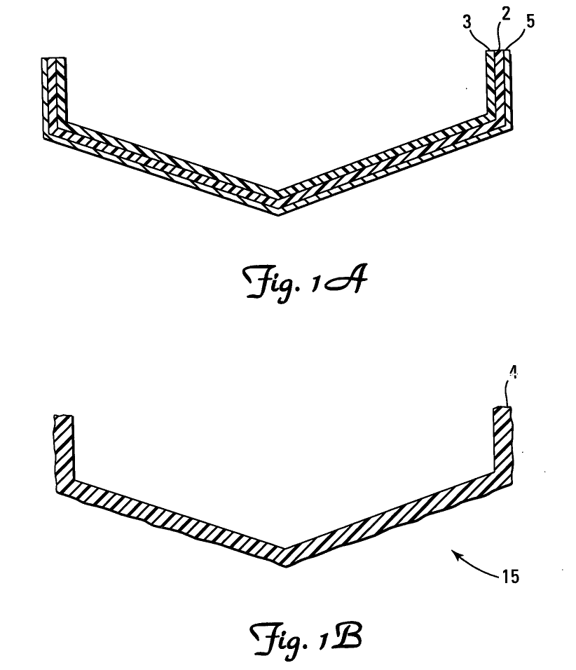

The mold comprises silicone or similar materials that have good release characteristics and has the desired surface details formed into it. The resin and stone or mineral particle mixture is poured into the mold and spread into a thin layer so that the entire mold surface is coated (i.e., layer 2 in FIG. 1A). This layer ranges in thickness from about 0.09 inches to about 0.12 inches (0.24 cm to 0.31 cm). Then a mixture of glass fibers and resin is added and spread into the mold at a similar thickness. After the resin has cured, and the cap has been removed from the mold, the surface of the capping block preferably is sandblasted to remove resin from the surface, thus revealing a naturally-appearing mineral or stone surface. Alternatively, the front surface may by polished in order to produce a polished stone look.

Typically, particles of the type of stone that the capping block is meant to resemble are used in the resin mixture, and these particles provide the color for the block. For example, if the capping block is intended to resemble natural granite, then granite particles are used in the mix. If limestone is the desired look, then fine particles of limestone may be used. Various powdered pigments may be added to the mix in order to create different colors or shades of color.

The mold surface can be configured to impart a surface texture to the material that resembles the texture of natural stone, a smooth surface, or any other desired appearance, typically including those textures that are commonly used with natural stone products.

It should be emphasized that the surface of a capping block may have any desired appearance. A natural appearance, such as stone, is generally most desirable. The capping blocks may also resemble stone that has been processed or treated as is commonly known in the natural stone industry. For example, the capping block may resemble weathered stone, polished stone, or flame treated stone. In addition, the mold may be configured to produce blocks that resemble stone that has been hand or machine pitched or tumbled to produce an aesthetically pleasing natural quarried stone appearance.

The capping blocks are produced in dimensions that are convenient to manufacture and handle, and these are consistent with desired and practical sizes of columns and pillars. For example, convenient sizes range from about 12 inches to 36 inches square (about 30.5 to 91.4 cm square). These dimensions may vary substantially in order to meet aesthetic or functional requirements of particular applications. Capping blocks of this invention about 22 inches square (55.9 cm square) weigh from about 15 to about 20 lbs (6.8 to 9.1 kg) compared to a limestone capping block of this size, which weighs about 120 lbs (54.5 kg). Clearly, this down-weighting is a significant advantage in both shipment of and installation of the blocks.

The capping block is impervious to water and salt spray, is resistant to freeze-thaw degradation and UV degradation, and is relatively light in weight.

As a result of these properties, the capping block of this invention provides not only greater beauty, but enhances the durability of the underlying columnar structure, since most concrete products become more vulnerable to freeze-thaw deterioration when salt water and freezing conditions are both present. The capping blocks also are formed of a material that discourages graffiti since it has an irregular surface, and from which graffiti may be removed more readily since it does not absorb spray paint as readily as concrete. A mold having a desired shape and size for forming a cap is shown in FIG. 1A. First layer 2 is poured and spread into mold 5. Second layer 3, containing resin mixed with glass fibers, is poured and spread onto layer 2. These two layers form cap 15, the outside of which, i.e., that portion next to the mold, has a desired texture and appearance, as shown in FIG. 1B. Edge 4 of cap 15 also has the desired texture.

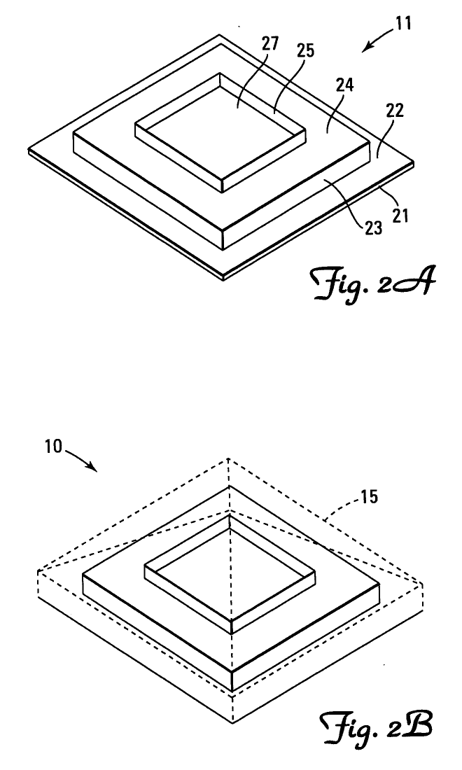

Shelf pan 11 in FIG. 2A is prepared from the mineral aggregate and has a desired shape and dimension. The layers in mold 5 may be cured or uncured before contact with shelf pan 11. The shelf pan is joined to the contents of mold 5 to form capping block 10, as shown in FIG. 2B.

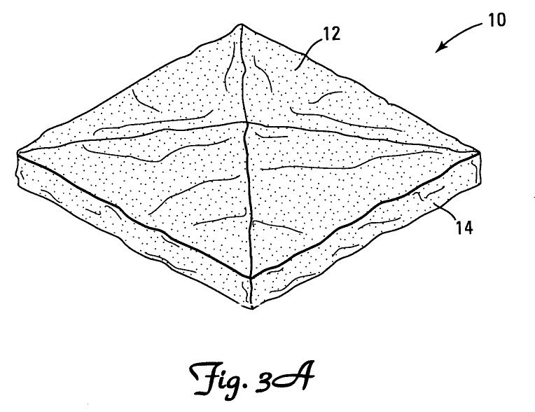

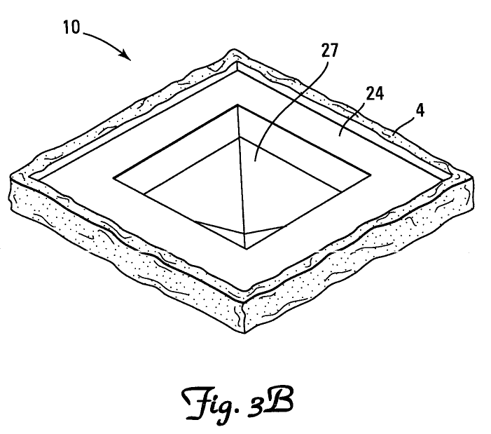

This capping block has a four-sided pyramidal shape with a natural stone appearance, as shown in FIG. 3A. The capping block may have various shapes as described further below. Top 12 of the block joins sides 14. Shelf pan 11 (FIG. 2A) is designed to form the bottom of the capping block, and has edge 21, lip 22, rise 23, surface 24 and wall 25 extending perpendicularly from surface 24. The presence of void or cavity 27 is determined by the shape of the shelf pan before it is joined to the cap. The bottom surface and the interior of cavity 27 typically and preferably is smooth, allowing for easy installation on a column, however lip 22 preferably is textured with the desirable surface appearance.

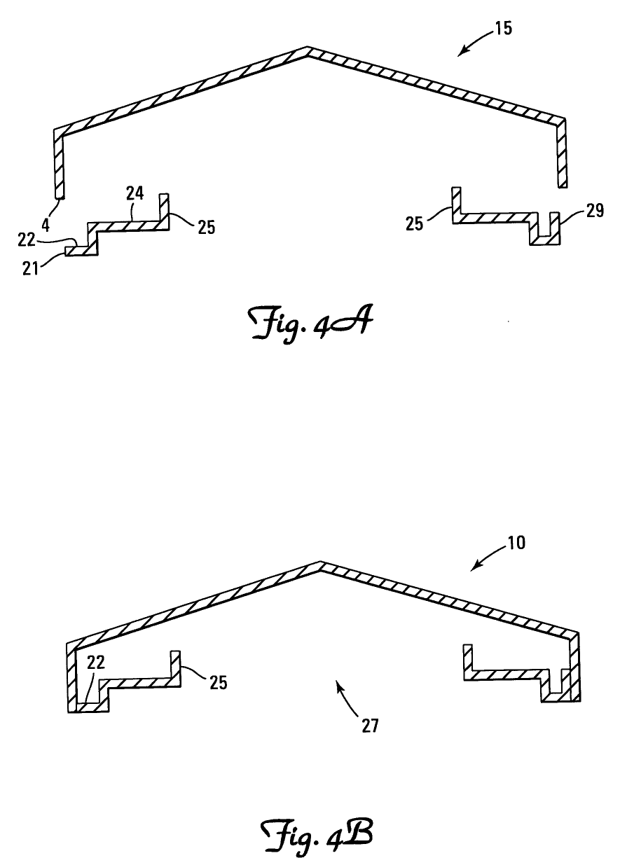

A sectional view showing how the shelf pan attaches to the cap is illustrated in FIGS. 4A and 4B. The shelf pan is configured to attach to the cap and form lip 22 at the inside periphery of the capping block. Void 27 is created by walls 25 when the shelf pan is joined to the cap. These walls are shown extending part way to cap 15, however, the walls may extend to and join with cap 15, or may be absent. The presence of walls 25 can be useful for the positioning of anchoring elements, as described further below.

FIGS. 4A and 4B also illustrate two ways in which the shelf pan can join the cap. For example, the shelf pan can join cap 15 at edge 21 (best seen in FIGS. 4A and 4B) or an additional segment 29 can be added to the shelf pan to increase the adhesive surface at the periphery of the shelf pan. As described above, the shelf pan can attach to the cap when the resin layers are uncured, or additional adhesive may be placed between edge 21 and cap 15 or between segment 29 and cap 15.

FIGS. 5A to 5C illustrate how the capping block can be used with a light fixture. Capping block 50 is provided with bore 52. The material from which the block is fabricated permits formation of this bore by a drill, for example.

Wires 55 are shown threaded through bore 52, electrically connecting light fixture 60 through conduit 57 installed within a core, bore, or void in a column (not shown). The interior shape of the capping block is shown in phantom. The light fixture can be screwed onto or otherwise attached to the capping block.

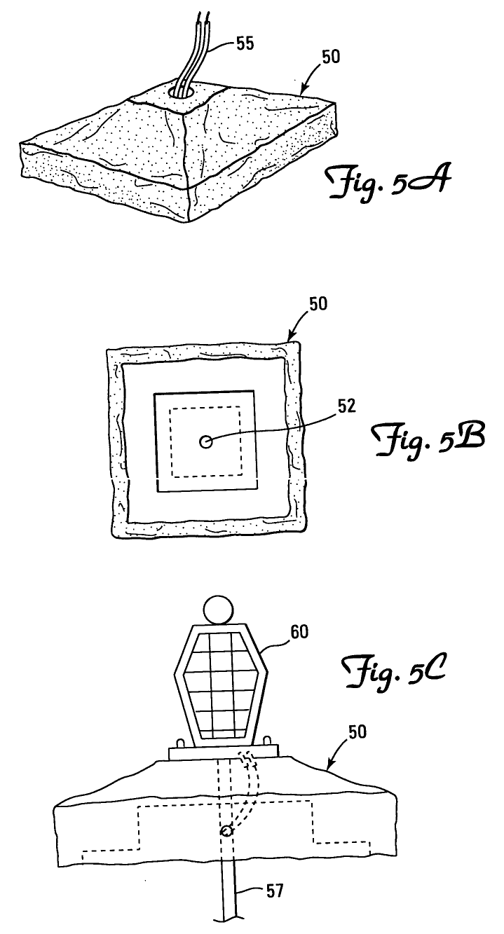

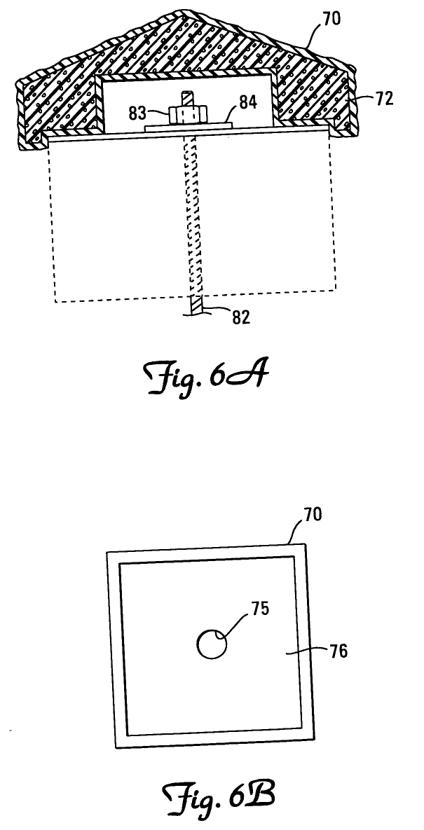

FIG. 6A shows a cut away view of capping block 70, which is similar to the capping blocks described above, except that it is filled with a foam insulation material 72, such as a honeycomb or foam matrix. The foam provides sound deadening. In addition, compression plate 76 is installed at the top of a column. The sectional view in FIG. 6B shows the compression plate relative to the capping block. Threaded rod 82 is placed through bore 75 of the compression plate and locked down by nut 83 and washer 84. The threaded rod is installed in the core or void space in the center of the column. The void in the capping block provides sufficient space for the threaded rod assembly.

The cap is preferably attached to the column using commonly available construction adhesives.

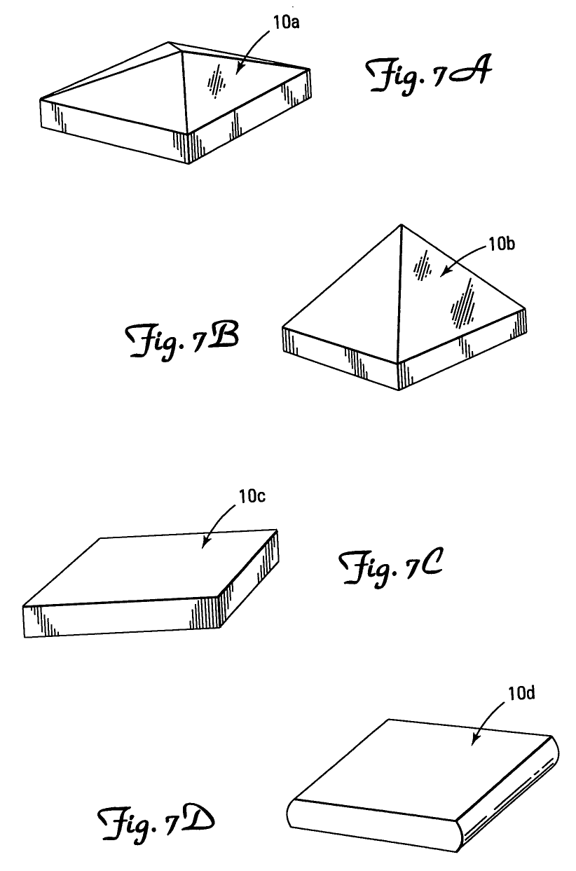

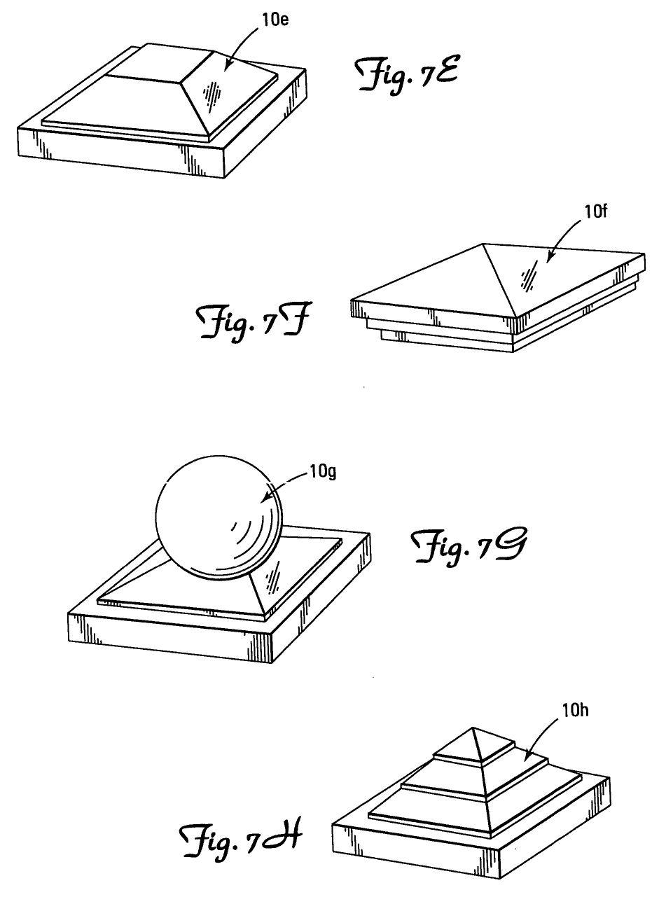

FIGS. 7A to 7H illustrate that the capping block may have various shapes. The capping blocks of this invention can be formed into any desirable shape and are not limited to the shapes illustrated. Capping blocks 10a to 10h may have textured or smooth surfaces, as desired for the intended application.

Although particular embodiments have been disclosed herein in detail, this has been done for purposes of illustration only, and is not intended to be limiting with respect to the scope of the following appended claims. In particular, it is contemplated by the inventors that various substitutions, alterations, and modifications may be made to the invention without departing from the spirit and scope of the invention as defined by the claims. For instance, the choices of materials or variations in shapes are believed to be a matter of routine for a person of ordinary skill in the art with knowledge of the embodiments disclosed herein.

1. A method of making a cap for a fence column comprising:
providing a mold having an interior surface;
adding a first material to the mold to form a first layer adjacent the interior surface, the first material comprising a mixture of mineral aggregate and resin;
adding a second material to the mold over the first material to form a second layer adjacent to the first layer, the second material comprising a mixture of glass fibers and resin;
allowing the first and second layers to cure, the first and second layers together forming a first portion of the cap;
removing the first portion from the mold;
providing a second portion of the cap shaped to fit over the top of a fence column; and
attaching the first portion to the second portion.

2. The method according to claim 1, wherein allowing the first and second layers to cure further allows the first and second layers to bond to each other.

3. The method according to claim 1, wherein the cap is formed with a perimeter lip.

4. The method according to claim 1, wherein the cap is hollow.

5. The method according to claim 1, wherein the cap is filled with insulation.

6. The method according to claim 1, wherein the mineral aggregate is a natural stone aggregate.

7. The method according to claim 1, wherein allowing the first and second layers to cure includes accelerating the curing with heat.

8. The method according to claim 1, further comprising forming a shelf pan.

9. The method according to claim 8, further comprising joining the shelf pan to the cap.

10. The method according to claim 9, wherein the shelf pan is joined to the cap with uncured resin or adhesive.
